(19) United States
(12) Patent Application Publication
(10) Pub. No.: US 2021/0179120 A1
(43) Pub. Date: Jun. 17, 2021

(54) VEHICLE DATA CLASSIFYING METHOD AND VEHICLE DATA CLASSIFYING DEVICE

(71) Applicant: HONDA MOTOR CO., LTD., Tokyo (JP)

(72) Inventors: Shinya YOSHINO, TOKYO (JP); Shuichiro YOSHIDA, TOKYO (JP); Yudai OKABE, TOKYO (JP)

(21) Appl. No.: 17/120,832

(22) Filed: Dec. 14, 2020

(30) Foreign Application Priority Data
Dec. 17, 2019 (JP) 2019-227062

(51) Int. Cl. B60W 50/02; B60W 50/04; G07C 5/08

(52) U.S. Cl. CPC B60W 50/0205; B60W 50/04; B60W 2556/25; G07C 5/0808; G07C 5/0841

(57) ABSTRACT

Repeatedly performing a process of selecting vehicle data within a second time from time-series data, while shifting a selection range by a third time and causing a portion of the previous selection range and a portion of the current selection range to overlap, and determining a vehicle state indicated by the vehicle data included in each of the selection ranges; and selecting a detection time period of the vehicle data to be classified, selecting all of the selection ranges that include the vehicle data of the selected detection time period, identifying the vehicle state that is most numerous among one or more vehicle states indicated by the vehicle data included in the selected selection ranges, and classifying all of the types of vehicle data detected in the selected detection time period as data of the identified vehicle state.

### CROSS-REFERENCE TO RELATED APPLICATION

This application is based upon and claims the benefit of priority from Japanese Patent Application No. 2019-227062 filed on Dec. 17, 2019, the contents of which are incorporated herein by reference.

### BACKGROUND OF THE INVENTION

### Field of the Invention

The present invention relates to a vehicle data classifying method and a vehicle data classifying device that acquire time-series data and classify vehicle data.

### Description of the Related Art

Japanese Patent No. 4928532 discloses a failure diagnosis device that is connected to a vehicle including a data collecting device and performs a diagnosis of a failure of the vehicle. The data collecting device on the vehicle side sequentially collects vehicle data (velocity, engine rotational velocity, and the like) detected by each sensor provided in each section of the vehicle, and stores the vehicle data in time series (time-series data). Furthermore, the failure diagnosis device acquires the time-series data from the data collecting devices of a plurality of vehicles and generates a reference value (normal value). The failure diagnosis device is connected to a vehicle that has experienced a failure, and performs the failure diagnosis by acquiring the vehicle data from the data collecting device and comparing this vehicle data to the reference value that was generated in advance.

When generating the reference value (normal value), the failure diagnosis device sequentially divides the time series data at prescribed time intervals (3 sec). For example, the failure diagnosis device divides the time-series data into vehicle data of a detection time period from T1 to T2, vehicle data of a detection time period from T2 to T3, . . . , and vehicle data of a detection time period from Tn−1 to Tn. For each individual piece of vehicle data resulting from this division, the failure diagnosis device determines the vehicle state (acceleration, deceleration, or the like) indicated by this piece of vehicle data. The failure diagnosis device then classifies each individual piece of vehicle data according to the determined vehicle state, and generates a reference value for each vehicle state based on the classified vehicle data.

### SUMMARY OF THE INVENTION

When generating the reference values, the failure diagnosis device of Japanese Patent No. 4928532 sequentially divides the time-series data at prescribed time periods to create the plurality of pieces of vehicle data. This method has the following problem. As an example, there are cases where both vehicle data detected during acceleration and vehicle data detected during deceleration are included in one piece of vehicle data. The failure diagnosis device of Japanese Patent No. 4928532 classifies such a piece of vehicle data as one of acceleration or deceleration. If this piece of vehicle data is classified as acceleration vehicle data, for example, then vehicle data detected during deceleration is included in the vehicle data classified as acceleration data. In such a case, the accuracy of the acceleration reference value decreases. As a result, the accuracy of the failure diagnosis decreases.

The present invention has been devised taking into consideration the aforementioned problem, and has the object of providing a vehicle data classifying method and a vehicle data classifying device that can improve the accuracy of the vehicle data classification.

A first aspect of the present invention is:

a vehicle data classifying method for acquiring time-series data made up of one or more types of vehicle data detected every first time by one or more sensors of a vehicle and classifying the vehicle data, the vehicle data classifying method including:

a state determination step of repeatedly performing a process of selecting the vehicle data within a second time that is longer than the first time from the time-series data made up of a prescribed type of the vehicle data, while shifting a current selection range by a third time in a direction of passage of time relative to a previous selection range and causing a portion of the previous selection range and a portion of the current selection range to overlap, and determining the vehicle state indicated by the vehicle data included in each of the selection ranges; and a data classification step of selecting a detection time period of the vehicle data to be classified, selecting all of the selection ranges that include the vehicle data of the selected detection time period, identifying the vehicle state that is most numerous among one or more vehicle states indicated by the vehicle data included in the selected selection ranges, and classifying all of the types of vehicle data detected in the selected detection time period as data of the identified vehicle state.

A second aspect of the present invention is:

a vehicle data classifying device that acquires time-series data made up of one or more types of vehicle data detected every first time by one or more sensors of a vehicle and classifies the vehicle data, the vehicle data classifying device including:

a state determining section configured to repeatedly perform a process of selecting the vehicle data within a second time that is longer than the first time from the time-series data made up of a prescribed type of the vehicle data, while shifting a current selection range by a third time in a direction of passage of time relative to a previous selection range and causing a portion of the previous selection range and a portion of the current selection range to overlap, and determine the vehicle state indicated by the vehicle data included in each of the selection ranges; and a data classifying section configured to select a detection time period of the vehicle data to be classified, selects all of the selection ranges that include the vehicle data of the selected detection time period, identifies the vehicle state that is most numerous among one or more vehicle states indicated by the vehicle data included in the selected selection ranges, and classify all of the types of vehicle data detected in the selected detection time period as data of the identified vehicle state.

According to the present invention, it is possible to accurately classify vehicle data of each detection time period according to the vehicle state.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 shows a configuration of a vehicle and a failure diagnosis device (vehicle data classifying device) according to a first embodiment;

FIG. 2 shows an association between the velocity data and the vehicle state;

FIG. 3 shows a flow of a data collecting process performed by the vehicle;

FIG. 4 shows a flow of a data classifying process performed by the first embodiment;

FIG. 5 shows vehicle data transitions and selected velocity data selection ranges in the first embodiment;

FIG. 6 shows a flow of a state determining process using the velocity data and the engine rotation data;

FIG. 7 shows the configuration of a vehicle and a failure diagnosis device (vehicle data classifying device) according to a second embodiment;

FIG. 8 shows the flow of the data classifying process performed by the second embodiment;

FIG. 9 shows vehicle data transitions and selected velocity data selection ranges in the first embodiment;

FIG. 10 shows the flow of a state determining process using shift position data; and

FIG. 11 shows the flow of a state determining process using IG level data, engine rotation data, and accelerator position data.

### DESCRIPTION OF THE PREFERRED EMBODIMENTS

The following describes preferred embodiments of a vehicle data classifying method and a vehicle data classifying device according to the present invention, while referencing the accompanying drawings.

### 1. First Embodiment

### [1.1. Configuration of the Failure Diagnosing System 10]

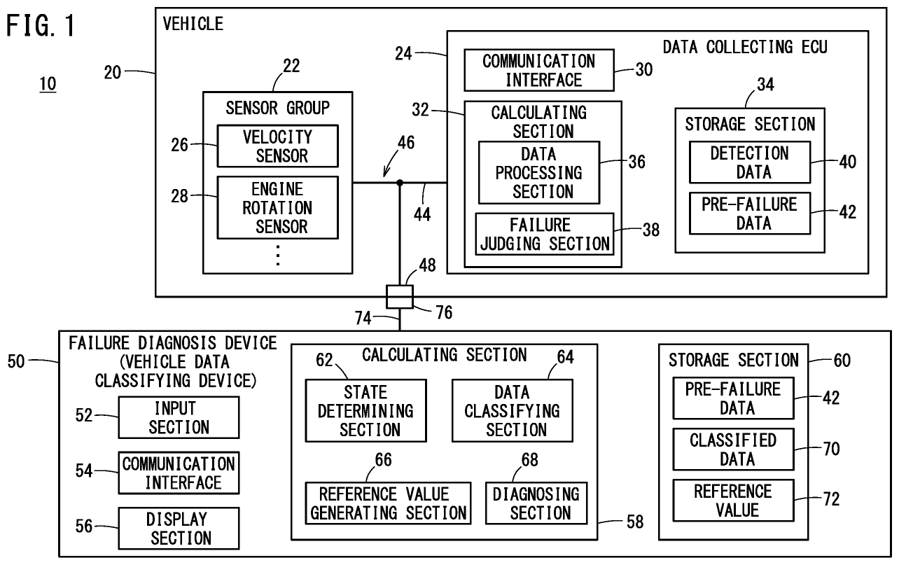

The failure diagnosis system 10 shown in FIG. 1 includes a vehicle 20 and a failure diagnosis device 50. The vehicle 20 is brought into a store that sells vehicles 20 when inspections or repairs are to be made. The failure diagnosis device 50 is provided in the sales store. In the first embodiment, the failure diagnosis device 50 functions as a vehicle data classifying device.

### [1.2. Configuration of the Vehicle 20]

The vehicle 20 is a gasoline vehicle that includes an engine for driving. The vehicle 20 may be a hybrid vehicle that includes a motor for driving in addition to an engine.

The vehicle 20 includes a sensor group 22 and a data collecting ECU 24. The sensor group 22 includes one or more sensors that are provided to each section of the vehicle 20 and detect various types of vehicle data. The sensor group 22 includes, for example, a velocity sensor 26 that detects the travel velocity of the vehicle 20 and an engine rotation sensor 28 that detects the rotational velocity of the engine. In addition to these, the sensor group 22 includes, for example, a sensor that detects the temperature of an engine coolant, a sensor that detects intake air pressure, a sensor that detects the throttle opening amount, and the like. Furthermore, the sensor group 22 may include a shift position sensor (including a gear position sensor, reverse switch, parking switch, and the like) that detects the shift position. The sensor group 22 may include a Hall sensor that detects the ignition level (ignition ON and ignition OFF) and an accelerator position sensor that detect an accelerator position.

The data collecting ECU 24 includes a communication interface 30, a calculating section 32, and a storage section 34. The calculating section 32 includes a processor. The storage section 34 includes various storage devices (RAM, ROM, hard disk, and the like).

The calculating section 32 realizes various functions by having the processor execute a program stored in the storage section 34. In the first embodiment, the calculating section 32 functions as a data processing section 36 and a failure judging section 38. The functions of the data processing section 36 and the failure judging section 38 are described below in section [1.4].

The storage section 34 stores the program and the like to be executed by the calculating section 32. Furthermore, the storage section 34 stores detection data 40 and pre-failure data 42. The detection data 40 is made up of one or more types of vehicle data detected by the sensor group 22. The detection data 40 is data in which a detection time period Tn (n is a natural number) and vehicle data detected by each sensor in this detection time period Tn are associated with each other. The pre-failure data 42 is the detection data 40 from the failure occurrence timing to a prescribed time (e.g., 15 seconds) before the failure occurrence timing. The detection data 40 and the pre-failure data 42 are time-series data.

The sensor group 22, the data collecting ECU 24, and other ECUs described further below (not shown in the drawings) are connected via a communication bus 44, and form a network 46 such as an F-CAN or B-CAN. The communication bus 44 includes a data link connector 48 (e.g., a USB connector) provided inside the vehicle cabin. The failure diagnosis device 50 can be connected to the network 46 via the data link connector 48.

### [1.3. Configuration of the Failure Diagnosis Device 50]

The failure diagnosis device 50 is formed by a computer (such as a personal computer, a tablet computer, a smartphone, or a specialized electronic device), for example. The failure diagnosis device 50 includes an input section 52, a communication interface 54, a display section 56, a calculating section 58, and a storage section 60. The input section 52 includes a human-machine interface such as a touch panel, a keyboard, and a mouse. The display section 56 includes a display. The calculating section 58 includes a processor. The storage section 60 includes various storage devices (RAM, ROM, hard disk, and the like).

The calculating section 58 realizes various functions by having the processor execute programs stored in the storage section 60. In the first embodiment, the calculating section 58 functions as a state determining section 62, a data classifying section 64, a reference value generating section 66, and a diagnosing section 68. The functions of the state determining section 62 and the data classifying section 64 are described further below in section [1.5]. The reference value generating section 66 reads classified data 70 from the storage section 60, and performs a prescribed calculation to generate a normal value, i.e., a reference value 72. The diagnosing section 68 reads the time-series data from the vehicle 20 that is the target of the failure diagnosis, determines the vehicle state indicated by the read time-series data, reads the reference value 72 corresponding to the determined vehicle state from the storage section 60, and compares the time-series data to the reference value 72 to make the diagnosis. In this Specification, descriptions of a specific method for generating the reference value 72 and a specific method for diagnosing failure of the vehicle 20 are omitted.

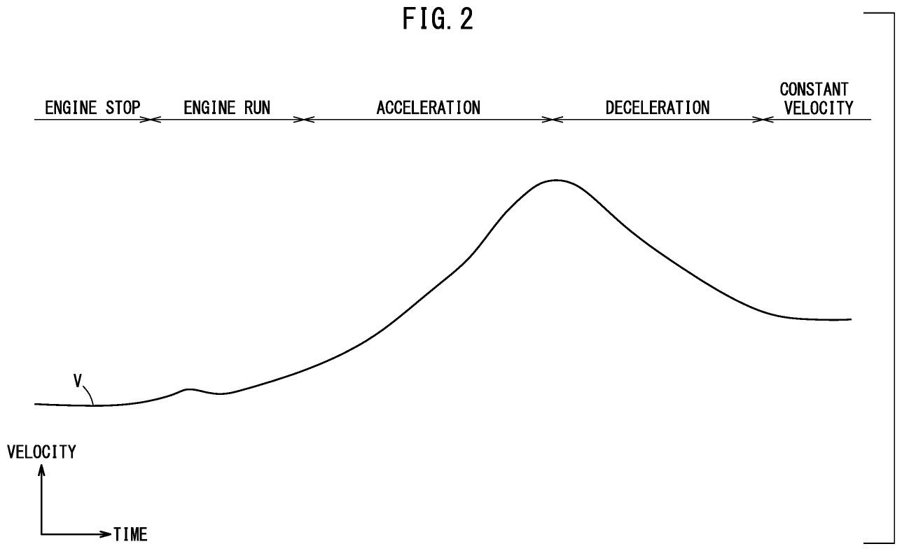

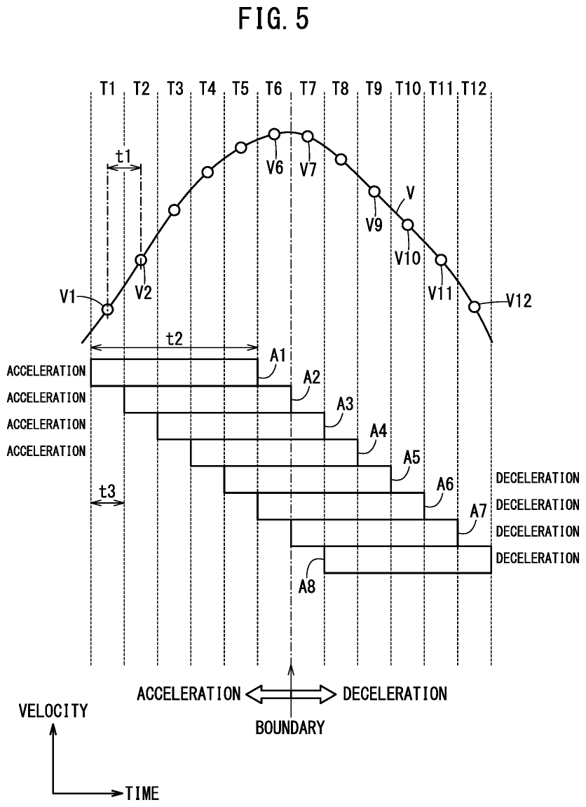

The storage section 60 stores the programs and the like to be executed by the calculating section 58. Furthermore, the storage section 60 stores the classified data 70 and the reference value 72, as described above. The classified data 70 is a collection of a plurality of types of vehicle data acquired from each vehicle 20. The plurality of types of vehicle data included in the classified data 70 are classified based on the vehicle state in the detection time period Tn of the vehicle data. As shown in FIG. 2, the five states of “engine stop”, “engine RUN”, “acceleration”, “deceleration”, and “constant velocity” are set as the vehicle states in the first embodiment. FIG. 2 shows transitions of the velocity data V serving as the detection data 40, and also shows the association (relationship) between the transition of the velocity data V, the velocity data V, and the vehicle state. The transition of the velocity data V is shown by a line in FIG. 2, but is actually a collection of pieces of point data (see FIG. 5). The reference value 72 is generated for each vehicle state.

### [1.4. Data Collecting Process Performed by the Vehicle 20]

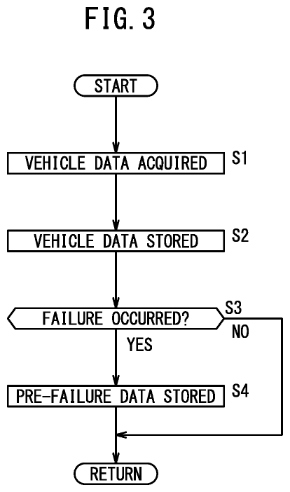

The data collecting process performed by the vehicle 20 is described using FIG. 3. The process described below is performed every prescribed time (first time t1, e.g., 200 msec), from when the power supply of the vehicle 20 is turned ON to when the power supply of the vehicle 20 is turned OFF.

At step S1, the data processing section 36 acquires each type of vehicle data from each sensor included in the sensor group 22. When step S1 ends, the process moves to step S2.

At step S2, the data processing section 36 stores each type of vehicle data that has been acquired in the storage section 34, as the detection data 40. At this time, the data processing section 36 attaches the detection time period Tn to each type of vehicle data, and links pieces of vehicle data having the same detection time period Tn to each other. The amount of the detection data 40 is extremely large, and the capacity of the storage section 34 would be insufficient to store all of the pieces of vehicle data. Therefore, when storing new vehicle data in the storage section 34 as the detection data 40, the data processing section 36 deletes the detection data 40 having the oldest detection time period Tn. When step S2 ends, the process moves to step S3.

At step S3, the failure judging section 38 judges whether a failure has occurred. The failure judging section 38 detects a failure by receiving a failure code (DTC: Diagnostic Trouble Code) transmitted from another ECU (not shown in the drawings). The failure judging section 38 also detects a failure by receiving a failure trigger, such as engine stalling and startup problems. If a failure has occurred (step S3: YES), the process moves to step S4. On the other hand, if a failure has not occurred (step S3: NO), the current series of processes ends.

At step S4, the failure judging section 38 extracts the pre-failure data 42, from the failure occurrence timing (DTC reception timing or the like) to a timing that is a prescribed time before this failure occurrence timing, from the detection data 40 and stores this pre-failure data 42 in the storage section 34. When step S4 ends, the current series of processes ends.

### [1.5. Data Classifying Process Performed by the Failure Diagnosis Device 50]

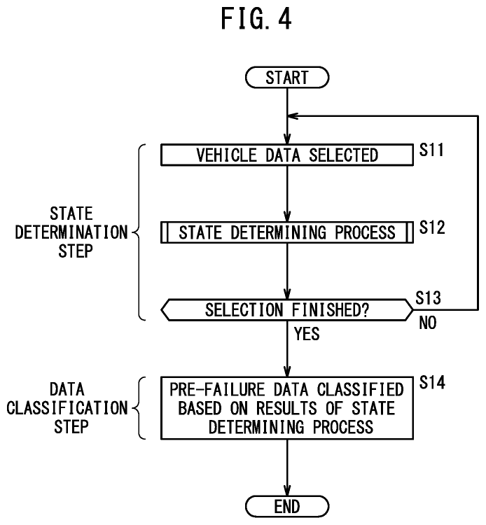

The data classifying process performed by the failure diagnosis device 50 (vehicle data classifying device) is described using FIGS. 4 to 6. A salesperson connects a connector 76 of a data link cable 74, which is connected to the failure diagnosis device 50, to the data link connector 48 of the vehicle 20 that has been brought into the sales store. In this state, when the input section 52 of the failure diagnosis device 50 is manipulated, the pre-failure data 42 is forwarded from the storage section 34 of the vehicle 20 to the storage section 60 of the failure diagnosis device 50. Furthermore, when the input section 52 is manipulated, the state determining section 62 reads the velocity data V included in the pre-failure data 42 from the storage section 60, and the process shown in FIG. 4 is performed. Steps S11 to S13 shown in FIG. 4 are a state determination step. Step S14 is a data classification step. The process shown in FIG. 4 is started with n being equal to 1.

At step S11, the state determining section 62 selects the vehicle data in the detection time period Tn, which in this case is the velocity data V in a prescribed time (second time t2, e.g., 3 sec) starting from the detection time period for the velocity data V. The second time t2 is a longer time than the first time t1. The process performed in step S11 is described using FIG. 5.

FIG. 5 shows transitions of the velocity data V detected each first time t1 by the velocity sensor 26 of the vehicle 20, and the selection range Am of the velocity data V selected at step S11. The velocity data V includes the velocity data V detected in the detection time periods T1 to T12. In the description using FIG. 5, for the sake of convenience, the numerical examples described above in which the first time t1=200 msec and the second time t2=3 sec are not used.

In the process of step S11 performed first, the state determining section 62 selects velocity data V spanning the second time t2, which has a time width of the second time t2 in the direction of the passage of time (a direction toward later detection time periods Tn) starting from the detection time period T1, which is the piece of velocity data V whose detection time period Tn is earliest. The time range of the second time t2 is referred to as the selection range Am. The letter “m” appended to the end of the letter “A” indicates the number of times the velocity data V has been selected, i.e., the number of times the process of step S11 has been performed. The range selected when the process of step S11 is performed for the first time is A1.

The range selected when the process of step S11 is performed for the second time is A2. The range selected when the process of step S11 is performed for the m-th time is Am. The velocity data V of the detection time periods T1 to T5 is included in the initial selection range A1. When the selection of the velocity data V ends, the process moves to step S12.

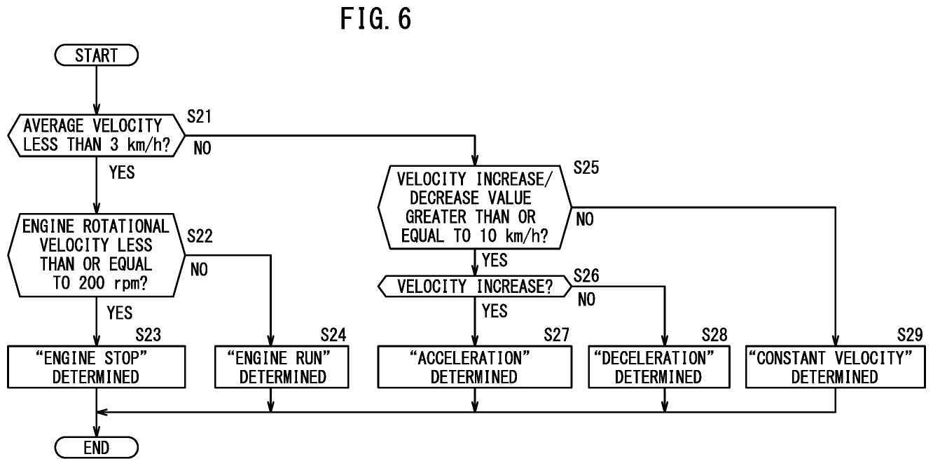

At step S12, the state determining section 62 determines the vehicle state indicated by the velocity data V selected at step S11. This process is referred to as the state determining process. An example of the state determining process is described using FIG. 6. The specific numerical values used in the following description are merely examples, and the present invention is not limited to these values.

At step S21, the state determining section 62 calculates the average value of the velocity data V included in the selection range Am. For example, in the process of step S21 performed for the first time, the state determining section 62 calculates the average value of each piece of velocity data V in the detection time periods T1 to T5 included in the selection range A1. The state determining section 62 then determines whether the average value (average velocity) is less than 3 km/h. If the average velocity is less than 3 km/h (step S21: YES), the process moves to step S22. On the other hand, if the average velocity is greater than or equal to 3 km/h (step S21: NO), the process moves to step S25.

At step S22, the state determining section 62 calculates the average value of the engine rotation data linked to the velocity data V included in the selection range Am. For example, in the process of step S21 performed for the first time, the state determining section 62 calculates the average value of the engine rotation data of the detection time periods T1 to T5 included in the selection range A1. The state determining section 62 then determines whether the average value (engine rotation) is less than or equal to 200 rpm. If the engine rotation is less than or equal to 200 rpm (step S22: YES), the process moves to step S23. On the other hand, if the engine rotation is greater than 200 rpm (step S22: NO), the process moves to step S24.

At step S23, the state determining section 62 determines the vehicle state indicated by the velocity data V included in the selection range Am to be “engine stop”, from among the five vehicle states shown in FIG. 2.

At step S24, the state determining section 62 determines the vehicle state indicated by the velocity data V included in the selection range Am to be “engine RUN”, from among the five vehicle states shown in FIG. 2.

When moving from step S21 to step S25, the state determining section 62 calculates an increase/decrease value of the velocity in the selection range Am. For example, the state determining section 62 calculates the velocity difference between a maximum value and a minimum value of the velocity data V included in the selection range Am. The state determining section 62 then determines whether the velocity increase/decrease value is greater than or equal to 10 km/h. If the velocity increase/decrease value is greater than or equal to 10 km/h (step S25: YES), the process moves to step S26. On the other hand, if the velocity increase/decrease value is less than 10 km/h (step S25: NO), the process moves to step S29.

At step S26, the state determining section 62 determines whether the velocity data V included in the selection range Am is a velocity increase or a velocity decrease. For example, the state determining section 62 compares the velocity data Va, whose detection time period Tn is earliest, to the velocity data Vb, whose detection time period Tn is latest, among the pieces of velocity data V included in the selection range Am. The state determining section 62 then determines the velocity data V to be a velocity increase if velocity data Va≤velocity data Vb, and determines the velocity data V to be a velocity decrease if velocity data Va>velocity data Vb. If the velocity data V is a velocity increase (step S26: YES), the process moves to step S27. If the velocity data V is a velocity decrease (step S26: NO), the process moves to step S28.

At step S27, the state determining section 62 determines the vehicle state indicated by the velocity data V included in the selection range Am to be “acceleration”, among the five vehicle states shown in FIG. 2.

At step S28, the state determining section 62 determines the vehicle state indicated by the velocity data V included in the selection range Am to be “deceleration”, among the five vehicle states shown in FIG. 2.

When moving from step S25 to step S29, the state determining section 62 determines the vehicle state indicated by the velocity data V included in the selection range Am to be “constant velocity”, among the five vehicle states shown in FIG. 2.

As described above, in the state determining process performed at step S12 of FIG. 4, the state determining section 62 determines the vehicle state indicated by the velocity data V included in the selection range Am. In FIG. 5, the determination results of the vehicle state for these selection ranges Am are shown on the right side or left side of the selection ranges A1 to A8. Here, the vehicle state indicated by the velocity data V included in the selection ranges A1 to A4 is “acceleration”, and the vehicle state indicated by the velocity data V included in the selection ranges A5 to A8 is “deceleration”.

At step S13, the state determining section 62 determines whether the selection of the velocity data V at step S11 has ended. If the selection has ended (step S13: YES), the process moves to step S14. On the other hand, if the selection has not ended (step S13: NO), the process returns to step S11.

When returning from step S13 to step S11, a value of 1 is added to n of the detection time period Tn and to m of the selection range Am. The state determining section 62 shifts the current selection range Am by a prescribed time (third time t3) in the direction of the passage of time (direction toward later detection time periods Tn) from the previous selection range Am−1, and selects the velocity data V. The third time t3 is a time that is greater than or equal to the first time t1. Here, the state determining section 62 causes a portion of the previous selection range Am−1 and a portion of the current selection range Am to overlap. For example, in a case where the previous selection range Am−1 is the selection range A1 and the current selection range Am is the selection range A2, the state determining section 62 shifts the selection range A2 by the third time t3 in the direction of the passage of time from the selection range A1, and selects the velocity data V of the detection time periods T2 to T6. The selections ranges A1 and A2 overlap in a range of the detection time periods T2 to T5.

The process of step S11 and the process of step S12 are performed repeatedly until there are no more pieces of velocity data V to be selected. In the example of FIG. 5, after the selection ranges A1 to A8 have been sequentially selected, there is no more velocity data V following the detection time period T12, that is, there are no more pieces of velocity data V to be selected. At this timing, the state determining section 62 determines that the selection has ended.

At step S14, the data classifying section 64 classifies the pre-failure data 42 stored in the storage section 60 into one of the five vehicle states, based on the results of the state determining process of step S12. The process performed in step S14 is described using FIG. 5 again.

First, the data classifying section 64 selects the detection time period T1. The data classifying section 64 selects all of the selection ranges Am that include the velocity data V1 of the detection time period T1, which is the selection range A1 in the example shown in FIG. 5, and identifies the vehicle state indicated by the velocity data V included in this selection range A1, which is “acceleration” in this case. The data classifying section 64 then ultimately classifies the detected velocity data V1 of the detection time period T1 as data for “acceleration”.

Next, the data classifying section 64 selects the detection time period T2. The data classifying section 64 selects all of the selection ranges Am that include the velocity data V2 of the detection time period T2, which are the selection ranges A1 and A2 in the example shown in FIG. 5. Furthermore, the data classifying section 64 identifies the vehicle state that is most numerous among the one or more vehicle states indicated by the pieces of velocity data V included in these selection ranges A1 and A2, which is “acceleration” in this case. The data classifying section 64 then ultimately classifies the detected velocity data V2 of the detection time period T2 as data for “acceleration”.

The data classifying section 64 sequentially selects the detection time periods Tn and classifies the velocity data V of these detection time periods Tn, in the same manner as in the process for classifying the pieces of velocity data V1 and V2 of the detection time periods T1 and T2.

The following describes a process in a case where the data classifying section 64 has selected the detection time period T6. The data classifying section 64 selects all of the selection ranges Am that include the velocity data V6 of the detection time period T6, which are the selection ranges A2 to A6 in the example shown in FIG. 5. The vehicle state indicated by the velocity data V included in the selection ranges A2 to A4 is “acceleration”, and the vehicle state indicated by the velocity data V included in the selection ranges A5 and A6 is “deceleration”. The data classifying section 64 identifies the vehicle state that is most numerous among the one or more vehicle states indicated by the pieces of velocity data V included in these selection ranges A2 to A6, which is “acceleration” in this case. The data classifying section 64 then ultimately classifies the detected velocity data V6 of the detection time period T6 as data for “acceleration”.

The following describes a process in a case where the data classifying section 64 has selected the detection time period T7. The data classifying section 64 selects all of the selection ranges Am that include the velocity data V7 of the detection time period T7, which are the selection ranges A3 to A7 in the example shown in FIG. 5. The vehicle state indicated by the velocity data V included in the selection ranges A3 and A4 is “acceleration”, and the vehicle state indicated by the velocity data V included in the selection ranges A5 to A7 is “deceleration”. The data classifying section 64 identifies the vehicle state that is most numerous among the one or more vehicle states indicated by the pieces of velocity data V included in these selection ranges A3 to A7, which is “deceleration” in this case. The data classifying section 64 then ultimately classifies the detected velocity data V7 of the detection time period T7 as data for “deceleration”.

As a result of the processes described above, the data classifying section 64 classifies the velocity data V of the detection time periods T1 to T6 as “acceleration”, and classifies the velocity data V of the detection time periods T7 to T12 as “deceleration”. The data classifying section 64 then stores the classified velocity data V in the storage section 60 as the classified data 70. The data classifying section 64 sets a boundary between “acceleration” and “deceleration”, between the detection time period T6 and the detection time period T7.

Furthermore, aside from the velocity data V, the data classifying section 64 classifies the vehicle data of the detection time periods T1 to T6 as “acceleration” and classifies the vehicle data of the detection time periods T7 to T12 as “deceleration”.

Due to the processes described above, all of the pre-failure data 42 is classified as “acceleration” or “deceleration”. Although a specific description is omitted, vehicle data is classified as “engine stop”, “engine RUN”, and “constant velocity” in the same manner.

### 2. Second Embodiment

In the first embodiment, as shown in FIG. 5, the velocity data V of the detection time periods T5 to T8 is included in five selection ranges Am, while the velocity data V of the detection time periods T1 to T4 and T9 to T12 is only included in four or fewer selection ranges Am. The state determination accuracy for the velocity data V of a detection time period Tn is higher when there are more selection ranges Am. In other words, the state determination accuracy for the velocity data V of the detection time periods T5 to T8 is relatively high, but the state determination accuracy for the velocity data V of the detection time periods T1 to T4 and T9 to T12 is relatively low. The second embodiment described below can make the state determination accuracy for the velocity data V of the detection time periods T1 to T4 and T9 to T12 be approximately the same as the state determination accuracy for the detection time periods T5 to T8.

### [2.1. Configuration of the Failure Diagnosing System 10]

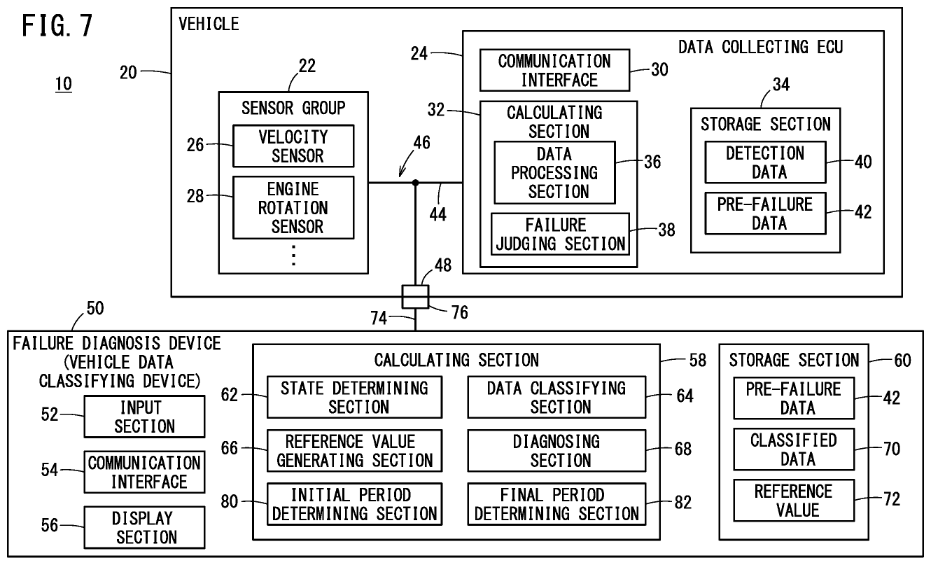

As shown in FIG. 7, the failure diagnosis system 10 according to the second embodiment differs from the failure diagnosis system 10 of the first embodiment in that the calculating section 58 also functions as an initial period determining section 80 and a final period determining section 82.

[2.2. Data Collecting Process Performed by the Vehicle 20]

The data collecting process performed by the vehicle 20 in the second embodiment is the same as the data collecting process performed by the vehicle 20 in the first embodiment.

[2.3. Data Classifying Process Performed by the Failure Diagnosis Device 50]

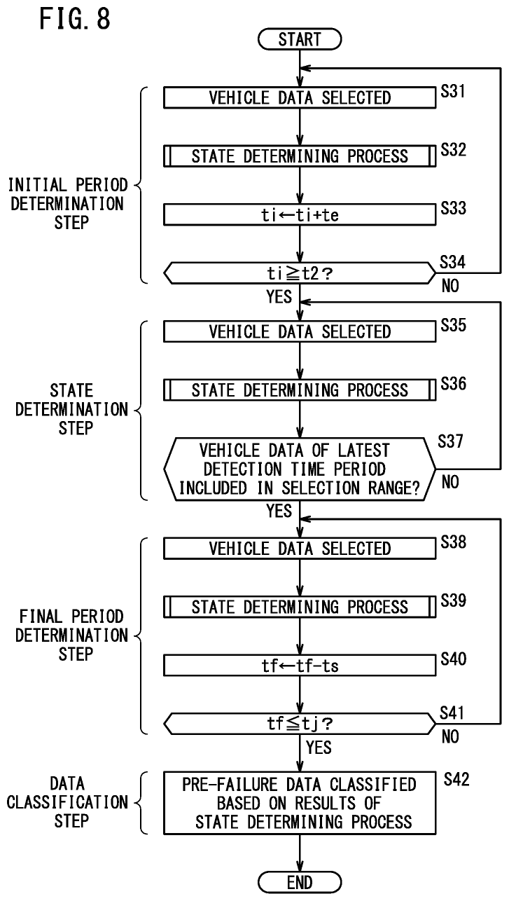

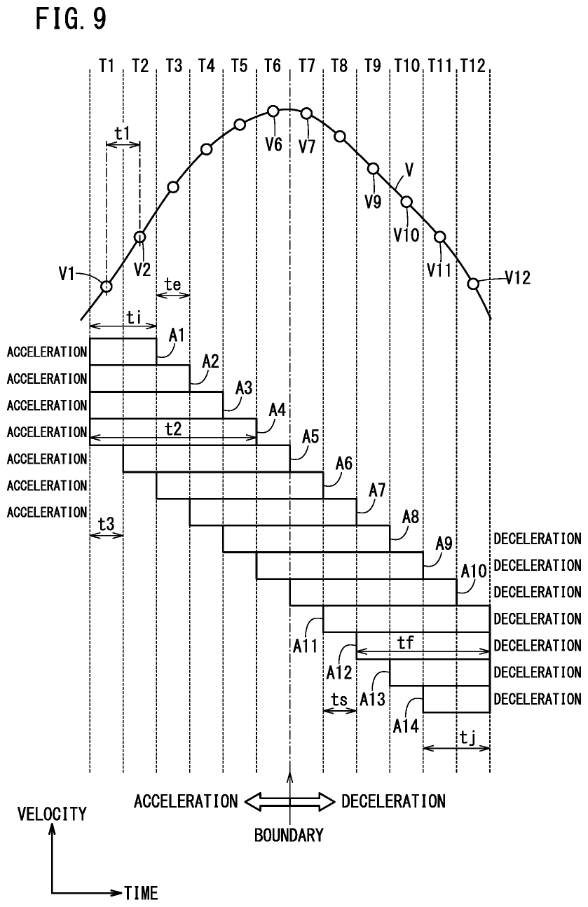

The data classifying process in the second embodiment is described using FIGS. 8 and 9. In the second embodiment, in the same manner as in the first embodiment, a sales person connects the failure diagnosis device 50 to the vehicle 20, and when the input section 52 is manipulated, the process shown in FIG. 8 is performed. Steps S31 to S34 shown in FIG. 8 are an initial period determination step. Steps S35 to S37 are the state determination step. Steps S38 to S41 are a final period determination step. Step S42 is the data classification step. The process shown in FIG. 8 is started with n being equal to 1 (n=1).

At step S31, the initial period determining section 80 selects the vehicle data of the detection time period Tn, which in this case is the velocity data V that is within an initial period time t1 that is shorter than the second time t2 and includes the velocity data V1 whose detection time period Tn is earliest among the pieces of velocity data V. In the example shown in FIG. 9, in step S31 being performed for the first time, the initial period determining section 80 sets the initial period time t1 to be two times the first time t1 (t1×2). In the same manner as in the first embodiment, the time range of the initial period time t1 is referred to as the selection range Am. In FIG. 9, the selection range A1 initially set by the initial period determining section 80 includes the pieces of velocity data V1 and V2 of the detection time periods T1 and T2. When the selection of the velocity data V ends, the process moves to step S32.

At step S32, the initial period determining section 80 determines the vehicle state indicated by the velocity data V selected at step S31. Here, the initial period determining section 80 performs the state determining process shown in FIG. 6, instead of the state determining section 62. When the state determining process ends, the process moves to step S33.

At step S33, the initial period determining section 80 adds an extension time te to the initial period time ti, to create a new initial period time ti. This means extending the selection range Am+1 (e.g., the selection range A2) by the extension time te in the direction of the passage of time relative to the selection range Am (e.g., the selection range A1). As an example, the extension time te is set to be the first time t1. When the extending of the selection range Am ends, the process moves to step S34.

At step S34, the initial period determining section 80 determines whether the new initial period time t1 is greater than or equal to the second time t2. If the initial period time t1 is greater than or equal to the second time t2 (step S34: YES), the process moves to step S35. At this timing, the processing by the initial period determining section 80 ends and the processing by the state determining section 62 starts. On the other hand, if the initial period time t1 is less than the second time t2 (step S34: NO), the process returns to step S31. At this timing, the initial period determining section 80 performs the process of step S31 on the new initial period time ti. In the example shown in FIG. 9, the velocity data V of the selection ranges A1 to A3 is selected before moving to step S35.

The processes of steps S35 and S36 are the same as the processes of steps S11 and S12 shown in FIG. 4. Therefore, descriptions of steps S35 and S36 are omitted.

At step S37, the state determining section 62 determines whether the velocity data V12, whose detection time period Tn is latest among the pieces of velocity data V, is included in the selection range Am. If the velocity data V12 is included in the selection range Am (step S37: YES), the process moves to step S38. At this timing, the processing by the state determining section 62 ends and the processing by the final period determining section 82 starts. On the other hand, if the velocity data V12 is not included in the selection range Am (step S37: NO), the process returns to step S35. In the example shown in FIG. 9, the velocity data V of the selection ranges A4 to A11 is selected before moving to step S38.

At step S38, the final period determining section 82 selects the velocity data V that is within a final period time tf that is shorter than the second time t2 and includes the velocity data V12 whose detection time period Tn is latest among the pieces of velocity data V. In the example shown in FIG. 9, in step S38 being performed for the first time, the final period determining section 82 sets the final period time tf to be four times the first time t1 (t1×4). In the same manner as in the first embodiment, the time range of the final period time tf is referred to as the selection range Am. In FIG. 9, the selection range A12 initially set by the final period determining section 82 includes the pieces of velocity data V9 to V12 of the detection time periods T9 to T12. When the selection of the velocity data V ends, the process moves to step S39.

At step S39, the final period determining section 82 determines the vehicle state indicated by the velocity data V selected at step S38. Here, the final period determining section 82 performs the state determining process shown in FIG. 6, instead of the state determining section 62. When the state determining process ends, the process moves to step S40.

At step S40, the final period determining section 82 subtracts a shortening time ts from the final period time tf, to create a new final period time tf. This means shortening the next selection range Am+1 (e.g., the selection range A12) by the shortening time ts in the direction of the passage of time relative to the current selection range Am (e.g., the selection range A11). As an example, the shortening time ts is set to be the first time t1. When the shortening of the selection range Am ends, the process moves to step S41.

At step S41, the final period determining section 82 determines whether the new final period time tf is greater than or equal to an end determination time tj. In the example shown in FIG. 9, the final period determining section 82 sets the end determination time tj to be two times the first time t1 (t1×2). If the final period time tf is less than or equal to the end determination time tj (step S41: YES), the process moves to step S42. On the other hand, if the final period time tf is greater than the end determination time tj (step S41: NO), the process returns to step S38. At this timing, the final period determining section 82 performs the process of step S38 on the new final period time tf.

The process of step S42 is the same as the process of step S14 shown in FIG. 4. Here, the data classifying section 64 classifies the pre-failure data 42 stored in the storage section 60 as one of the five vehicle states, based on the results of the determining processes of steps S32, S36, and S39.

In order for the initial period determining section 80 and the final period determining section 82 to make the determinations concerning acceleration and deceleration, the velocity data V of at least two detection time periods Tn and Tn+1 is necessary. Therefore, in the examples described above, the shortest initial period time t1 and end determination time tj are each set to be two times the first time t1 (t1×2). In a case of classification where the vehicle data of two detection time periods Tn and Tn+1 is not necessary, the shortest initial period time t1 and end determination time tj may each be set to e the first time t1.

### 3. Modifications

In the embodiments described above, the vehicle 20 includes an engine. Instead, a vehicle 20 that does not include an engine may be used. For example, the vehicle 20 may be an electric vehicle (including a fuel cell vehicle) or the like that includes only a traction motor. In this case, the process of step S22 shown in FIG. 6 is replaced with a different process.

In the embodiments described above, the failure diagnosis device 50 temporarily stores the pre-failure data 42 in the storage section 60, and classifies the vehicle data included in the pre-failure data 42. Instead, the failure diagnosis device 50 may temporarily store the detection data 40 in the storage section 60, and classify the vehicle data included in the pre-failure data 42. In this case, the failure diagnosis device 50 may sequentially acquire the vehicle data of each vehicle 20, via a wireless communication device.

The second time t2 or the third time t3 may be capable of being adjusted to be shorter or longer through a manipulation of the input section 52.

In the embodiments described above, the various types of vehicle data are classified into the five vehicle states (acceleration, deceleration, and the like), based on the velocity data V and the engine rotation data included in the vehicle data. However, the present invention is not limited to these embodiments. The various types of vehicle data may be classified into other vehicle states, based on data other than the velocity data V and the engine rotation data.

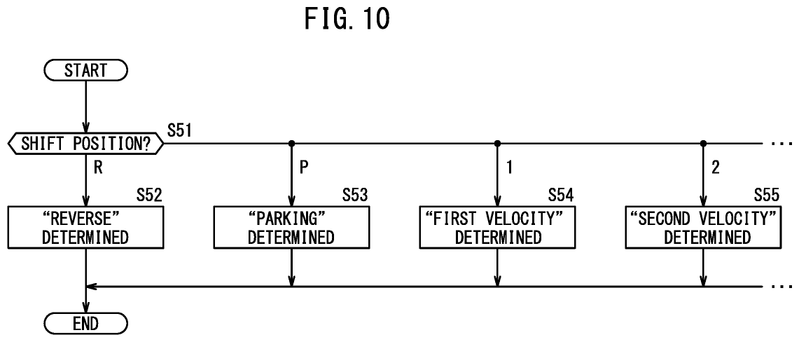

As an example, the various types of vehicle data may be classified into vehicle states such as “parking”, “reverse”, “first velocity”, “second velocity”, etc. based on the shift position data included in the vehicle data. The shift position data is vehicle data indicating the detection result of the shift position sensor. FIG. 10 shows the flow of the state determining process in this case.

At step S51, the state determining section 62, the initial period determining section 80, and the final period determining section 82 (referred to as the “state determining section 62 and the like”) determine the shift position based on the shift position data. The state determining section 62 and the like then classify the shift position data as any of “reverse” (step S52), “parking” (step S53), “first velocity” (step S54), “second velocity” (step S55), etc.

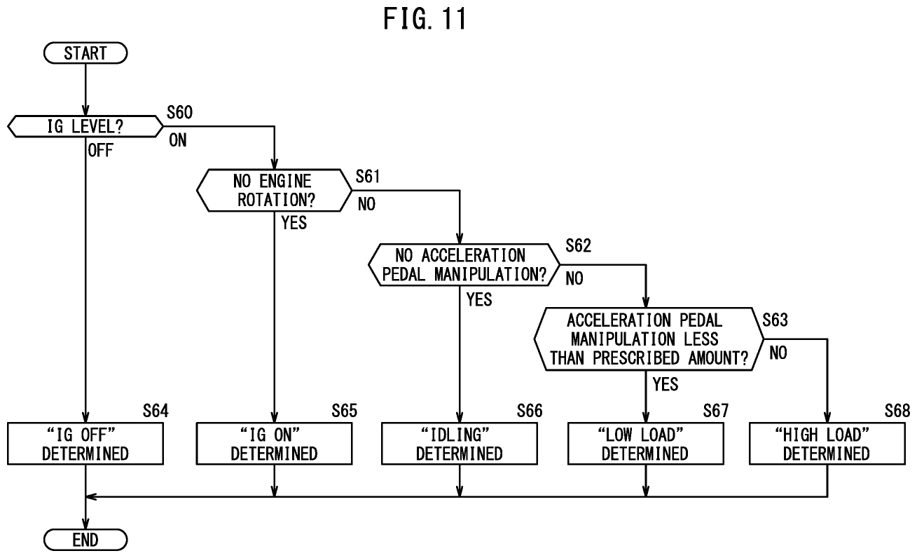

As another example, the various types of vehicle data may be classifies into vehicle states such as “IG OFF”, “IG ON”, “idling”, “low load”, and “high load”, based on ignition (IG) level data, the engine rotation data, and the accelerator position data included in the vehicle data. The IG level data is vehicle data indicating the detection result of the Hall sensor. The accelerator position data is vehicle data indicating the detection result of the accelerator position sensor. FIG. 11 shows the flow of the state determining process in this case.

At steps S60 to S63, the state determining section 62 and the like determine the IG level, whether there is engine rotation, and the manipulation amount of the acceleration pedal, based on the IG level data, the engine rotation data, and the accelerator position data. The state determining section 62 then classifies the IG level data, the engine rotation data, and the accelerator position data as any of “IG OFF” (step S64), “IG ON” (step S65), “idling” (step S66), “low load” (step S67), and “high load” (step S68).

In the embodiments described above, the failure diagnosis device 50 classifies the pre-failure data 42 collected by the vehicle 20 into each of the prescribed vehicle states, and generates the reference value 72 of each type of vehicle data for each vehicle state. The reason for generating the reference value 72 using the pre-failure data 42 is that the vehicle data before failure is thought of as being vehicle data during normal operation. From the viewpoint of generating the reference value 72 based on normal vehicle data, the failure diagnosis device 50 may acquire the vehicle data collected at another timing from the vehicle 20.

[4. Technical Concepts Obtainable from the Embodiments]

The following is a record of the technical concepts that can be understood from the embodiments and modifications described above.

A first aspect of the present invention is the vehicle data classifying method for acquiring time-series data (detection data 40, pre-failure data 42) made up of one or more types of vehicle data detected every first time t1 by one or more sensors (sensor group 22) of a vehicle 20 and classifying the vehicle data, the vehicle data classifying method including:

the state determination step (steps S11 to S13, steps S35 to S37) of repeatedly performing a process of selecting the vehicle data within a second time t2 that is longer than the first time t1 from the time-series data made up of a prescribed type of the vehicle data (velocity data V), while shifting a current selection range Am by a third time t3 in a direction of the passage of time relative to a previous selection range Am−1 and causing a portion of the previous selection range Am−1 and a portion of the current selection range Am to overlap, and determining the vehicle state indicated by the vehicle data included in each of the selection ranges Am; and

the data classification step (steps S14, S42) of selecting a detection time period Tn of the vehicle data to be classified, selecting all of the selection ranges Am that include the vehicle data of the selected detection time period Tn, identifying the vehicle state that is most numerous among one or more vehicle states indicated by the vehicle data included in the selected selection ranges Am, and classifying all of the types of vehicle data detected in the selected detection time period Tn as data of the identified vehicle state.

According to the above configuration, the vehicle data of each detection time period Tn is included in the one or more types of vehicle data (velocity data V, engine rotation data, and the like), and all of the types of vehicle data detected in these detection time periods Tn is classified based on the vehicle state indicated by the one or more types of vehicle data. Therefore, according to the configuration described above, all of the types of vehicle data detected in each detection time period Tn can be accurately classified according to the vehicle state.

In the vehicle data classifying method according to the first aspect, the third time t3 may be the same as the first time t1.

According to the above configuration, since the detection interval (first time t1) for the vehicle data and the time interval (third time t3) by which the selection range Am is shifted are the same, it is possible to clearly comprehend the boundary between vehicle states.

In the vehicle data classifying method according to the first aspect, the second time t2 may be adjustable.

When generating the reference value 72 for failure determination using vehicle data (velocity data V) that fluctuates significantly, if the selection range Am (second time t2) for the vehicle data is too long, there is a possibility that the fluctuation of the vehicle data (velocity data V) will become large in this selection range Am. When there is a large fluctuation in the vehicle data, the accuracy of the determination of the vehicle state indicated by the vehicle data becomes worse, and this causes the vehicle data classification accuracy to also become worse. According to the configuration described above, the selection range Am (second time t2) can be shortened, and therefore it is possible to handle vehicle data (velocity data V) that has significant fluctuation.

The vehicle data classifying method according to the first aspect may further include the initial period determination step (steps S31 to S34) of repeatedly performing a process of selecting the vehicle data that is in an initial period time t1 that is shorter than the second time t2 and includes the vehicle data (velocity data V1) whose detection time period Tn is earliest, from the time-series data (velocity data V) made up of the prescribed type of vehicle data, while extending the current selection Am range relative to the previous selection range Am−1 by a prescribed extension time to in the direction of the passage of time, and determining the vehicle state indicated by the vehicle data included in each selection range Am, wherein the initial period determination step may include, at a timing when the initial period time t1 has reached the second time t2, ending the initial period determination step (step S34: YES) and starting the state determination step (steps S35 to S37).

The vehicle data classifying method according to the first aspect may further include the final period determination step (steps S38 to S41) of repeatedly performing a process of selecting the vehicle data that is in a final period time tf that is shorter than the second time t2 and includes the vehicle data (velocity data V12) whose detection time period Tn is latest, from the time-series data made up of the prescribed type of vehicle data (velocity data V), while shortening the current selection range Am relative to the previous selection range Am−1 by a prescribed shortening time is in the direction of the passage of time, and determining the vehicle state indicated by the vehicle data included in each selection range Am, wherein the state determination step (steps S35 to S37) may include, at a timing when the vehicle data (velocity data V12) whose detection time period Tn is latest is included in the selection range Am, ending the state determination step (step S37: YES) and starting the final period determination step.

A second aspect of the present invention is the vehicle data classifying device (failure diagnosis device 50) that acquires time-series data (detection data 40, pre-failure data 42) made up of one or more types of vehicle data detected every first time t1 by one or more sensors (sensor group 22) of a vehicle 20 and classifies the vehicle data, the vehicle data classifying device including:

the state determining section 62 configured to repeatedly perform a process of selecting the vehicle data within a second time t2 that is longer than the first time t1 from the time-series data made up of a prescribed type of the vehicle data (velocity data V), while shifting a current selection range Am by a third time t3 in a direction of the passage of time relative to a previous selection range Am−1 and causing a portion of the previous selection range Am−1 and a portion of the current selection range Am to overlap, and determine the vehicle state indicated by the vehicle data included in each of the selection ranges Am; and

the data classifying section 64 configured to select a detection time period Tn of the vehicle data to be classified, selects all of the selection ranges Am that include the vehicle data of the selected detection time period Tn, identifies the vehicle state that is most numerous among one or more vehicle states indicated by the vehicle data included in the selected selection ranges Am, and classify all of the types of vehicle data detected in the selected detection time period Tn as data of the identified vehicle state.

The vehicle data classifying device according to the second aspect may further includes the initial period determining section 80 configured to repeatedly perform a process of selecting the vehicle data that is in an initial period time t1 that is shorter than the second time t2 and includes the vehicle data (velocity data V1) whose detection time period Tn is earliest, from the time-series data made up of the prescribed type of vehicle data (velocity data V), while extending the current selection range Am relative to the previous selection range Am−1 by a prescribed extension time to in the direction of the passage of time, and determine the vehicle state indicated by the vehicle data included in each selection range Am, wherein the initial period determining section 80 ends processing at a timing when the initial period time t1 has reached the second time t2, and the state determining section 62 starts processing at a timing when the processing of the initial period determining section 80 ends.

The vehicle data classifying device according to the second aspect may further include the final period determining section 82 configured to repeatedly perform a process of selecting the vehicle data that is in a final period time tf that is shorter than the second time t2 and includes the vehicle data (velocity data V12) whose detection time period Tn is latest, from the time-series data made up of the prescribed type of vehicle data (velocity data V), while shortening the current selection range Am relative to the previous selection range Am−1 by a prescribed shortening time is in the direction of the passage of time, and determine the vehicle state indicated by the vehicle data included in each selection range Am; wherein the state determining section 62 ends processing at a timing when the vehicle data (velocity data V12) whose detection time period Tn is latest is included in the selection range Am, and

the final period determining section 82 starts processing at a timing when the processing by the state determining section 62 ends.

According to the second aspect, the same effects as the first aspect are realized.

The vehicle data classifying method and vehicle data classifying device according to the present invention are not limited to the above-described embodiments, and it goes without saying that various configurations could be adopted without departing from the scope of the present invention.

For example, the present invention is effective not only for the failure data stored by a vehicle, but also for real-time time-series data frames acquired in response to a request of the failure diagnosis device. Furthermore, the failure diagnosis device can also be used as a logger (e.g., a memorator). The present invention is also effective for time-series data frames obtained by directly reading communication with an ECU of the vehicle from a bus, and not from a storage section.

What is claimed is:

1. A vehicle data classifying method for acquiring time-series data made up of one or more types of vehicle data detected every first time by one or more sensors of a vehicle and classifying the vehicle data, the vehicle data classifying method comprising:
a state determination step of repeatedly performing a process of selecting the vehicle data within a second time that is longer than the first time from the time-series data made up of a prescribed type of the vehicle data, while shifting a current selection range by a third time in a direction of passage of time relative to a previous selection range and causing a portion of the previous selection range and a portion of the current selection range to overlap, and determining the vehicle state indicated by the vehicle data included in each of the selection ranges; and
a data classification step of selecting a detection time period of the vehicle data to be classified, selecting all of the selection ranges that include the vehicle data of the selected detection time period, identifying the vehicle state that is most numerous among one or more vehicle states indicated by the vehicle data included in the selected selection ranges, and classifying all of the types of vehicle data detected in the selected detection time period as data of the identified vehicle state.

2. The vehicle data classifying method according to claim 1, wherein the third time is same as the first time.

3. The vehicle data classifying method according to claim 1, wherein the second time is adjustable.

4. The vehicle data classifying method according to claim 1, further comprising an initial period determination step of repeatedly performing a process of selecting the vehicle data that is in an initial period time that is shorter than the second time and includes the vehicle data whose detection time period is earliest, from the time-series data made up of the prescribed type of vehicle data, while extending the current selection range relative to the previous selection range by a prescribed extension time in the direction of the passage of time, and determining the vehicle state indicated by the vehicle data included in each selection range,
wherein the initial period determination step includes, at a timing when the initial period time has reached the second time, ending the initial period determination step and starting the state determination step.

5. The vehicle data classifying method according to claim 1, further comprising a final period determination step of repeatedly performing a process of selecting the vehicle data that is in a final period time that is shorter than the second time and includes the vehicle data whose detection time period is latest, from the time-series data made up of the prescribed type of vehicle data, while shortening the current selection range relative to the previous selection range by a prescribed shortening time in the direction of the passage of time, and determining the vehicle state indicated by the vehicle data included in each selection range,
wherein the state determination step includes, at a timing when the vehicle data whose detection time period is latest is included in the selection range, ending the state determination step and starting the final period determination step.

6. A vehicle data classifying device that acquires time-series data made up of one or more types of vehicle data detected every first time by one or more sensors of a vehicle and classifies the vehicle data, the vehicle data classifying device comprising:
a state determining section configured to repeatedly perform a process of selecting the vehicle data within a second time that is longer than the first time from the time-series data made up of a prescribed type of the vehicle data, while shifting a current selection range by a third time in a direction of passage of time relative to a previous selection range and causing a portion of the previous selection range and a portion of the current selection range to overlap, and determine the vehicle state indicated by the vehicle data included in each of the selection ranges; and
a data classifying section configured to select a detection time period of the vehicle data to be classified, selects all of the selection ranges that include the vehicle data of the selected detection time period, identifies the vehicle state that is most numerous among one or more vehicle states indicated by the vehicle data included in the selected selection ranges, and classify all of the types of vehicle data detected in the selected detection time period as data of the identified vehicle state.

7. The vehicle data classifying device according to claim 6, further comprising an initial period determining section configured to repeatedly perform a process of selecting the vehicle data that is in an initial period time that is shorter than the second time and includes the vehicle data whose detection time period is earliest, from the time-series data made up of the prescribed type of vehicle data, while extending the current selection range relative to the previous selection range by a prescribed extension time in the direction of the passage of time, and determine the vehicle state indicated by the vehicle data included in each selection range,
wherein the initial period determining section ends processing at a timing when the initial period time has reached the second time, and
the state determining section starts processing at a timing when the processing of the initial period determining section ends.

8. The vehicle data classifying device according to claim 6, further comprising a final period determining section configured to repeatedly perform a process of selecting the vehicle data that is in a final period time that is shorter than the second time and includes the vehicle data whose detection time period is latest, from the time-series data made up of the prescribed type of vehicle data, while shortening the current selection range relative to the previous selection range by a prescribed shortening time in the direction of the passage of time, and determine the vehicle state indicated by the vehicle data included in each selection range,
wherein the state determining section ends processing at a timing when the vehicle data whose detection time period is latest is included in the selection range, and
the final period determining section starts processing at a timing when the processing by the state determining section ends.
